(19) United States
(12) Patent Application Publication
(10) Pub. No.: US 2012/0173441 A1
(43) Pub. Date: Jul. 5, 2012

(54) Ownership Resolution System

(75) Inventors: Christopher LaRosa, San Francisco, CA (US); Jay Laefer, San Mateo, CA (US)

(73) Assignee: GOOGLE INC., Mountain View, CA (US)

(21) Appl. No.: 13/207,309

(22) Filed: Aug. 10, 2011

Related U.S. Application Data
(60) Provisional application No. 61/430,155, filed on Jan. 5, 2011.

(51) Int. Cl. G06Q 50/00

(52) U.S. Cl. 705/310

(57) ABSTRACT

A system and method for ownership resolution is disclosed. The system comprises a merge module, an ownership database and a decision engine. The merge module retrieves a unified table from the ownership database. The unified table includes ownership information that is converted to a standard format. The merge module is configured to merge the ownership information to form a final merge result based at least in part on one or more merging rules. The decision engine receives the final merge result from the merge module. The decision engine is configured to determine a real owner of a granular right based at least in part on the merged ownership information included in the final merge result.

### CROSS REFERENCE

This application claims priority from the following U.S. provisional patent application, which is hereby incorporated by reference: Ser. No. 61/430,155, filed on Jan. 5, 2011 and entitled “OWNERSHIP RESOLUTION SYSTEM.”

### BACKGROUND

The specification relates to data management systems. In particular, the specification relates to a system for resolving ownership of granular rights for an intellectual property asset.

An intellectual property asset (e.g., a video, a book, a song, a video game, etc.) frequently has more than one entity claiming to own the asset. The asset cannot be monetized until the real owner of the asset is identified. It is therefore necessary, when more than one entity claims ownership of an asset, to determine the real owner of the asset. Existing systems maintain a database of which entities own various intellectual property assets. However, these systems do not track ownership of granular rights for these intellectual property assets. Furthermore, any entity can assert that they or another entity own an intellectual property asset. Existing systems assume that such assertions are correct. However, some entities submit misleading information regarding the ownership of the intellectual property asset.

A first problem present in existing systems is that they do not track ownership of granular rights. For example, if a publisher wants to opt its composition works out of a particular country, all the granular rights for the composition would be blocked in the country since the existing systems do not track the owner of each granular right of each asset.

A second problem present in existing systems is that these systems rely on information submitted by entities that may misrepresent the ownership of the asset. This renders the ownership information stored in the database unreliable.

### SUMMARY OF THE INVENTION

The specification overcomes the deficiencies and limitations of the prior art at least in part by providing a system and method for resolving ownership of one or more granular rights for an intellectual property asset. The system comprises a merge module, an ownership database and a decision engine. The merge module is communicatively coupled to the ownership database. The merge module retrieves a unified table from the ownership database. The unified table includes ownership information that is converted to a standard format. The merge module is configured to merge the ownership information to form a final merge result based at least in part on one or more merging rules. The merged ownership information included in the final merge result includes only the most reliable ownership information received by the system. The decision engine is communicatively coupled to the merge module. The decision engine receives the final merge result from the merge module. The decision engine is configured to determine a real owner of a granular right based at least in part on the merged ownership information included in the final merge result.

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a high-level block diagram illustrating a system for resolving ownership of granular rights for an intellectual property asset according to one embodiment.

FIG. 2 is a block diagram illustrating an ownership resolution module according to one embodiment.

FIGS. 3 through 8 are block diagrams illustrating tables for ownership resolution.

FIG. 9 is a flow diagram of a method for ownership resolution according to one embodiment.

FIGS. 10A and 10B are flow diagrams of a method for ownership resolution according to another embodiment.

### DETAILED DESCRIPTION OF THE PREFERRED EMBODIMENTS

A system and method for resolving ownership of granular rights for an intellectual property asset is described below. In the following description, for purposes of explanation, numerous specific details are set forth in order to provide a thorough understanding of the specification. It will be apparent, however, to one skilled in the art that the embodiments can be practiced without these specific details. In other instances, structures and devices are shown in block diagram form in order to avoid obscuring the specification. For example, the specification is described in one embodiment below with reference to user interfaces and particular hardware. However, the description applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

Some embodiments can take the form of an entirely hardware embodiment, an entirely software embodiment or an embodiment containing both hardware and software elements. A preferred embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the various embodiments as described herein.

### System Overview

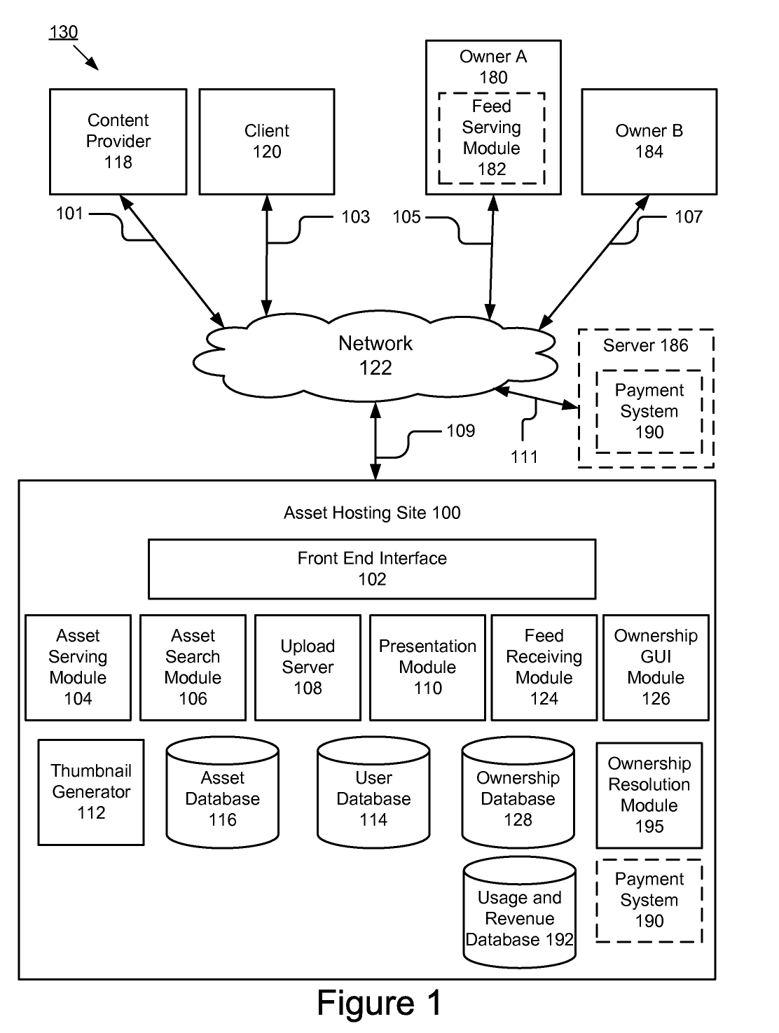

FIG. 1 is a high-level block diagram illustrating a system 130 for resolving ownership of one or more granular rights for an intellectual property asset according to one embodiment. The illustrated embodiment of the system 130 includes an asset hosting site 100, a content provider 118, a client 120, an owner A 180, an owner B 184 and a server 186. In the illustrated embodiment, these entities are communicatively coupled via a network 122. Although only one content provider 118, one client 120, one owner A 180, one owner B 184 and one server 186 are illustrated, persons having ordinary skill in the art will recognize that any number of content providers 118, clients 120, owners A 180, owners B 184 and servers 186 can be communicatively coupled to the network 122. Furthermore, while only one network 122 is coupled to the client 120, the content provider 118, the owner A 180, the owner B 184, the server 186 and the asset hosting site 100, persons having ordinary skill in the art will appreciate that any number of networks 122 can be connected to the client 120, the content provider 118, the owner A 180, the owner B 184, the server 186 and the asset hosting site 100.

The network 122 is a conventional type of network, wired or wireless, and may have any number of configurations such as a star configuration, token ring configuration or other configurations known to those skilled in the art. In one embodiment, the network 122 comprises one or more of a local area network (LAN), a wide area network (WAN) (e.g., the Internet), and/or any other interconnected data path across which multiple devices communicate. In another embodiment, the network 122 is a peer-to-peer network. The network 122 is coupled to or includes portions of a telecommunications network for sending data in a variety of different communication protocols. For example, the network is a 3G network or a 4G network. In yet another embodiment, the network 122 includes Bluetooth communication networks or a cellular communications network for sending and receiving data such as via short messaging service (SMS), multimedia messaging service (MMS), hypertext transfer protocol (HTTP), direct data connection, wireless application protocol (WAP), email, etc. In yet another embodiment, all or some of the links in the network 122 are encrypted using conventional encryption technologies such as secure sockets layer (SSL), secure HTTP and/or virtual private networks (VPNs).

In the illustrated embodiment, the asset hosting site 100 is communicatively coupled to the network 122 via signal line 109. The content provider 118 is communicatively coupled to the network 122 via signal line 101. The client 120 is communicatively coupled to the network 122 via signal line 103. The owner A 180 is communicatively coupled to the network 122 via signal line 105. The owner B 184 is communicatively coupled to the network 122 via signal line 107. The server 186 is communicatively coupled to the network 122 via signal line 111.

The asset hosting site 100 is any system that allows a user to access an intellectual property asset via searching and/or browsing interfaces. An example of an asset hosting site 100 is the YOUTUBE™ website, found at www.youtube.com. Other asset hosting sites are known as well, and are adapted to operate according to the teachings disclosed herein. It will be understood that the term “web site” represents any computer system adapted to serve content using any internet working protocols, and is not intended to be limited to content uploaded or downloaded via the Internet or the HTTP protocol.

In one embodiment, the asset hosting site 100 is configured to receive and share all or a portion of an intellectual property asset. Examples of an intellectual property asset include, but are not limited to: a video; one or more songs; a video game; a book; etc. Persons having ordinary skill in the art will also recognize that an intellectual property asset can be represented in any media type and/or file type. For example, the asset hosting site 100 shares content such as a video file, an audio file (e.g., one or more songs), a file that includes a combination of video and audio, an image file such as a JPEG or GIF file, a file including a video game program and/or a text file. An intellectual property asset is referred to as “an asset” hereinafter.

In one embodiment, sources of assets provided by the asset hosting site 100 are from uploads of assets by users, searches or crawls of other web sites or databases of assets, or the like, or any combination thereof. For example, in one embodiment, an asset hosting site 100 is configured to allow uploads of assets by users. In another embodiment, the asset hosting site 100 is configured to only obtain assets from other sources by crawling such sources or searching such sources in real time.

The asset hosting site 100 is communicatively coupled to the network 122. In the illustrated embodiment, the asset hosting site 100 includes: a front end interface 102; an asset serving module 104; an asset search module 106; an upload server 108; a presentation module 110; a thumbnail generator 112; a user database 114; an asset database 116; a feed receiving module 124; a graphical user interface module 126 (“GUI module 126”); an ownership database 128; an ownership resolution module 195; and a usage and revenue database 192. In one embodiment, the asset hosting site 100 further comprises a payment system 190. Here, the payment system 190 is depicted by a rectangle formed from a dashed line to indicate that in one embodiment the payment system 190 is comprised within the server 186. In one embodiment, the components of the asset hosting site 100 are communicatively coupled to one another. For example, they are communicatively coupled to one another via a bus (not pictured). Other conventional features, such as firewalls, load balancers, authentication servers, application servers, failover servers, site management tools, and so forth are not shown so as not to obscure the feature of the system.

In one embodiment, the illustrated components of the asset hosting website 100 are implemented as single pieces of software or hardware or as multiple pieces of software or hardware. In general, functions described in one embodiment as being performed by one component, can also be performed by other components in other embodiments, or by a combination of components. Furthermore, functions described in one embodiment as being performed by components of the asset hosting site 100 are performed by one or more clients 120 in other embodiments if appropriate. In one embodiment, the functionality attributed to a particular component is performed by different or multiple components operating together.

In one embodiment, each of the various servers and modules is implemented as a server program executing on a server-class computer comprising one or more central processing units (“CPU,” or “CPUs” if plural), memory, network interface, peripheral interfaces, and other well-known components. The computers themselves preferably run an open-source operating system such as LINUX, have generally high performance CPUs, 1 gigabyte or more of memory, and 100 gigabyte or more of disk storage. In one embodiment, other types of computers are used, and it is expected that as more powerful computers are developed in the future, they are configured in accordance with the teachings disclosed herein. In another embodiment, the functionality implemented by any of the elements is provided from computer program products that are stored in tangible computer accessible storage mediums (e.g., random access memory (“RAM”), flash, hard disk, optical/magnetic media, or solid-state drive (“SSD”), etc.).

The front end interface 102 is an interface that handles communication with one or more of the content provider 118, the client 120, the owner A 180, the owner B 184 and the server 186 via the network 122. For example, the front end interface 102 receives an asset uploaded from the content provider 118 and delivers the asset to the upload server 108. In one embodiment, the front end interface 102 receives requests from users of the client devices 120 and delivers the requests to the other components of the asset hosting site 100 (e.g., the asset search module 106 or the asset serving module 104). For example, the asset is a video and the front end interface 102 receives a video search query from a user and sends the video search query to the asset search module 106.

The upload server 108 receives one or more assets from the content provider 118 via the front end interface 102. For example, the upload server 108 receives one or more of a video file, an audio file (e.g., one or more songs), a file that includes a combination of video and audio, an image file such as a JPEG or GIF file, a file including a video game program and/or a text file from the content provider 118. In one embodiment, the upload server 108 processes the one or more assets and stores the processed assets in the asset database 116. The upload server 108 assigns an asset identification (“asset ID”) to the stored asset. An asset ID includes identifiers for videos (“video ID”), songs (“song ID”), images (“image ID”), video games (“video game ID”) and books (“book ID”). For example, the upload server 108 assigns a video ID to a video and stores the video together with the video ID in the asset database 116. In other embodiments, the upload server 108 performs one or more of: formatting an asset; compressing an asset; metadata tagging an asset; content analysis, etc.

The asset database 116 is a storage system that stores assets shared by the asset hosting site 100 with the users. In one embodiment, the asset database 116 stores the assets processed by the upload server 108. In another embodiment, the asset database 116 also stores metadata associated with the assets. The metadata includes one or more of: a title; a description; tag information; a time length; and the like. In one embodiment, some or all of the metadata of the assets is provided by the content provider 118. For example, a user of the content provider 118 provides a title and a description of an asset when uploading the asset to the asset hosting site 100.

The asset search module 106 includes code and routines that, when executed by a processor (not pictured), processes any search queries received by the front end interface 102 from users. A search query received by the front end interface 102 from a user includes search criteria such as keywords that identify an asset the user is interested in. The asset search module 106 uses the search criteria to query the metadata of the asset stored in the asset database 116. The search results for the query are returned to the front end interface 102 for presentation to the user. For example, if a user provides the front end interface 102 with a keyword search query, the asset search module 106 identifies an asset stored in the asset database 116 related to the keyword and returns the search result (e.g., asset IDs and/or metadata such as titles, descriptions, thumbnails of the identified assets) to the front end interface 102.

The asset serving module 104 includes code and routines that, when executed by a processor (not pictured), processes requests for an asset (e.g., a video, a book, a picture, a music file, etc) and provides the asset to users. For example, the asset serving module 104 receives a query from a user via the front end interface 102, retrieves a set of videos from the asset database 116 based at least in part on the query and presents the set of videos to the user via the front end interface 102.

In one embodiment, the asset serving module 104 receives a request from a user to access an asset when the user clicks on a link to the asset. The request received from the user includes the asset ID of the asset that the user wishes to access. In one embodiment, the asset ID is included automatically in the request once the user clicks on the link for the asset. The asset serving module 104 uses the asset ID to search and locate the asset in the asset database 116. Once the requested asset is located, the asset serving module 104 transmits the asset to the user via the front end interface 102. The asset is presented to the user on a web page. Metadata associated with the asset is also presented with the asset, such as the title and description of the asset. In one embodiment, the asset serving module 104 stores the asset ID of the asset in the user database 114 after sending the asset to the user so that an asset history of the user is stored in the user database 114.

The user database 114 is a storage system that stores data and/or information associated with a user. For example, the user database 114 stores the asset IDs of assets uploaded by a user to the asset hosting site 100 and the asset IDs of assets that the user has accessed from the asset database 116. In one embodiment, the user is identified by using a login name and password and/or by using the user's internet protocol address.

The thumbnail generator 112 includes code and routines that generates a thumbnail for an asset. A thumbnail is a picture that represents an asset in the asset hosting site 100. For example, assume the asset is a video. The thumbnail generator 112 analyzes the video and selects a frame of the video as the thumbnail. In one embodiment, the thumbnail generator 112 provides one or more pictures for the video and the user uploading the video to the asset hosting site 100 selects one picture as the thumbnail.

Entities such as the owner A 180 and the owner B 184 communicate with the asset hosting site 100 or the owner of the asset hosting site 100, and assert that they own rights for an asset via an ownership claim. The ownership claim includes ownership information associated with an asset. The asset hosting site 100 stores the ownership information in the ownership database 128. The ownership information is described in more detail below.

The ownership database 128 is a storage system that stores the ownership information. A purported owner is an entity that claims to own a percentage (0-100%) of one or more granular rights for an asset. The ownership resolution module 195 determines whether the purported owner is a real owner of the granular right. A granular right includes one or more of a public performance right, reproduction right, distribution right, sync right and a right to make a derivative work. Granular rights are jurisdiction specific. For example, a first entity may own the distribution right for an asset in the jurisdiction of the United States while, at the same time, a second entity owns the distribution right for the same asset in a different jurisdiction such as Brazil, India, China, Japan, etc.

An entity may not own 100% of a particular granular right. For example, a first entity is owner A 180 and a second entity is owner B 184. Owner A 180 owns 40% of the distribution right for an asset in the United States while owner B 184 owns 60% of the distribution right for the same asset in the United States.

An ownership claim is a statement asserting that an entity is an owner of one or more granular rights for an asset in a particular jurisdiction. For example, assume the asset is a song, the jurisdiction is the United States and the granular right is the distribution right for the song in the United States. Here an ownership claim is an assertion by an entity asserting ownership of the distribution right for the song in the jurisdiction of the United States. The ownership claim may assert that an entity is an owner of less than 100% of a granular right. An ownership claim is received from the entity that is specified in the ownership claim as the owner (referred to herein as a “self assertion” or “self submission”) or a third party that specifies the entity as the owner (referred to as a “third party assertion” or “third party submission”). For example, a self assertion occurs if the asset hosting site 100 receives an ownership claim from owner A 180 asserting that owner A 180 is the owner of one or more granular rights for an asset in a particular jurisdiction. By contrast, a third party assertion occurs if the asset hosting site 100 receives an ownership claim from owner B 184 asserting that owner A 180 is the owner of one or more granular rights for an asset in a particular jurisdiction. In one embodiment, self assertions are given preference over third party assertions by the ownership resolution module 195 in the determination of whether an entity is a real owner of a granular right. For the purpose of clarity, the entity identified in the ownership claim as the owner of a granular right is referred to as “the purported owner” and the entity that actually submits the ownership claim is referred to as “the asserting entity.”

These ownership claims are received by the asset hosting site 100 via one of two types of sources: manual submission or automated submission. An entity communicates a manual submission by completing of an electronic form generated and served by the asset hosting site 100, sending an e-mail to an e-mail account monitored by an administrator of the asset hosting site 100 or mailing a physical correspondence (e.g., a letter) to an administrator of the asset hosting site 100 using conventional snail mail. In one embodiment, an entity communicates via automated submission by setting up a feed including information for claiming ownership of one or more assets. For example, a feed for automated submissions of ownership claims is set up by owner A 180 via the feed serving module 182. In one embodiment, ownership claims received via manual submission are given preference over ownership claims received via automated submission by the ownership resolution module 195 in the determination of whether an entity is a real owner of a granular right. The feed serving module 182, manual ownership submissions and automated ownership submissions are described in more detail below.

In one embodiment, the ownership information includes one or more of the following: an identifier of the entity claiming ownership of a granular right for an asset (e.g., a name of the entity); an identifier of whether the ownership claim was submitted via self-submission or a third-party submission; an identifier of whether the ownership claim was received via manual submission or automated submission (referred to herein as “the source of the ownership claim”), an identifier of the jurisdiction in which the claimed ownership applies; a percentage of ownership claimed by the entity; an identifier of an administrator (e.g., a name of the administrator) for the granular right; a policy assigned to one or more granular rights of the asset by the administrator; a timestamp; and one or more geographic identifiers of the purported owner and/or the asserting entity.

A timestamp describes when an ownership claim was received. A geographic identifier identifies the geographical location of the purported owner or the asserting entity. For example, a user in California claims 50% of the public distribution rights for a video in the United States on Jan. 25, 2010. Here, the ownership information includes the timestamp “Jan. 25, 2010” and the geographic identifier “California.”

An administrator is a human that sets administrative policy for the granular right for which ownership is asserted. The policy assigned by the administrator indicates one or more administrative actions to be executed for the granular right. Examples of administrative actions include monetizing the granular right, blocking others from using the granular right and tracking others' use of the granular right. For example, the ownership information of a video specifies that owner A 180 owns 50% of the public performance right for an asset in the United States and that owner A 180 gives the asset hosting site 100 permission to monetize the public performance right in the United States.

The ownership resolution module 195 includes code and routines that, when executed by a processor (not shown) of the asset hosting site 100, determines a real owner of a granular right. In one embodiment, the ownership resolution module 195 retrieves ownership information from the ownership database 128, merges the retrieved ownership information to form a final merge result, determines a real owner for a granular right based at least in part on the final merge result and generates a report describing the real owner. In one embodiment, the ownership resolution module 195 generates a report describing an amount of money owed to the real owner for other's use of the real owner's granular right, and the report is delivered to a payment system 190 that takes steps to pay the real owner.

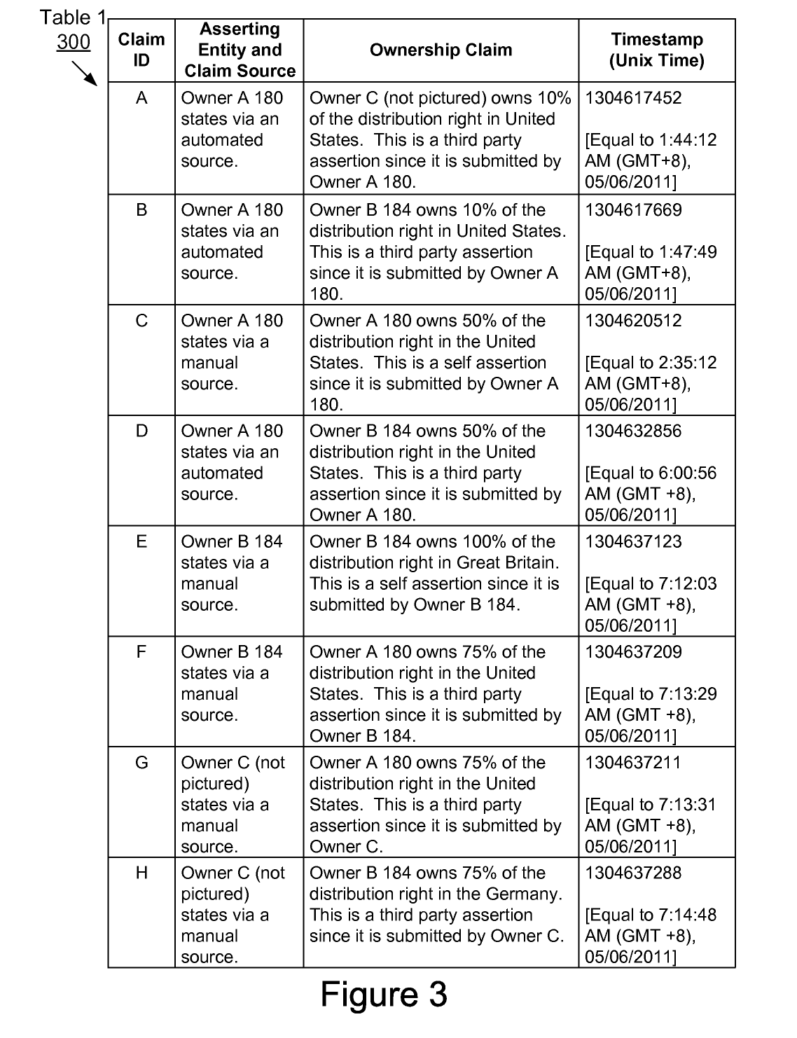

In one embodiment, the ownership resolution module 195 generates a unified table based at least in part on the ownership information retrieved from the ownership database 128. A unified table is a table that describes all or a subset of the ownership information for an asset. The information included in the unified table is standardized to a common format. In one embodiment, the unified table only includes information used by the ownership resolution module 195 to determine the real owner for one or more granular rights. For example, the unified table describes one or more of the following for one or more purported owners of a granular right: the identity of a purported owner; whether the ownership claim identifying the purported owner was received via manual submission or automated submission; whether the ownership claim identifying the purported owner was received via self assertion or third party assertion; the percentage of ownership claimed for the purported owner for each granular right; the jurisdiction claimed for each granular right; the geographic location of the purported owner; the geographic location of the asserting entity; a timestamp indicating the time when an ownership claim was received. The unified table is described in more detail below with reference to FIG. 3.

In one embodiment, merging the ownership information filters out some of the ownership information that is determined by the ownership resolution module 195 to be more reliable based at least in part on one or more of the following three merging rules: (1) ownership claims received via manual submission are more reliable than ownership claims received via automated submission (this rule is referred to herein as “the source rule”); (2) ownership claims received via self assertion are more reliable than ownership claims received via third party assertion (this rule is referred to herein as “the assert type rule”); (3) ownership claims received later in time are given priority over ownership claims received earlier in time (this rule is referred to herein as “the time rule”). In another embodiment, timestamps used to determine which ownership claim was received earlier in time are based on Universal Time (“UT”), Coordinated Universal Time (“UTC”) or Unix time.

In one embodiment, merging the ownership information comprises: (1) determining the ownership information for the one or more asserting entities; (2) ranking, for the one or more asserting entities, the ownership information from most reliable to least reliable based on the merging rules; and (3) filtering the more reliable ownership information for the one or more asserting entities to form a final merge result including only the most reliable ownership information for the one or more asserting entities. A final merge result is data describing the most reliable ownership information for the one or more asserting entities. The final merge result is formed by filtering the more reliable ownership information as described above. Merging ownership information is described in more detail with reference to FIGS. 3-9, 10A and 10B.

The feed receiving module 124 includes code and routines that, when executed by a processor (not pictured), processes a feed received by the front end interface 102. In one embodiment, the feed receiving module 124 receives a feed that includes data describing an ownership claim. The feed receiving module 124 extracts ownership information from the ownership claim and stores the ownership information in the ownership database 128. In one embodiment, the feed receiving module 124 receives a feed provided by one or more of the content provider 118, the client 120, the owner A 180 and/or the owner B 184. For example, the feed receiving module 124 receives a first portion of the feed from the owner A 180 and a second portion of the feed from the owner B 184.

The ownership GUI module 126 includes code and routines that, when executed by a processor (not pictured), provides graphic data for generating a GUI used by a human user to input ownership information. The ownership GUI module 126 is communicatively coupled to the front end interface 102. The ownership GUI module 126 transmits the graphical data to the front end interface 102. The front end interface 102 communicates with the network 122 to transmit the graphical data to a processor-based computing device communicatively coupled to the network 122. For example, the front end interface 102 transmits the graphical data to one or more of the content provider 118, client 120, owner A 180 and the owner B 184. One or more of the content provider 118, client 120, owner A 180 and the owner B 184 receives the graphical data and generates a GUI displayed on a display device (e.g., a monitor) communicatively coupled to the processor-based computing device. The GUI is displayed on a display device and viewed by the human user of one or more of the content provider 118, client 120, owner A 180 and the owner B 184. The GUI includes one or more fields, drop down boxes or other conventional graphics used by the human user to input the ownership information. Data inputted into the GUI is received by the front end interface 102 and stored in the ownership database 128.

The usage and revenue database 192 is a non-transitory computer-readable storage medium that stores usage data and revenue data. The usage data includes one or more of the following: a list of assets; the granular rights for the assets; a description of instances in which a granular right for an asset was used; an identifier of the real owner of the different granular rights; and an identifier of the entity that used the granular right. The revenue data is data describing how much a real owner should be compensated when another entity uses the real owner's granular right. In one embodiment, the usage data includes logs of views against videos that contain one or more assets stored in the asset database 116 and the revenue data includes information about the revenue generated from advertisements shown in conjunction with videos that are tracked in the usage data.

In one embodiment, the ownership resolution module 195 is communicatively coupled to the usage and revenue database 192 to store the real owners for the granular rights in the usage and revenue database 192. In another embodiment, the ownership resolution module 195 generates a merged report that describes the usage of one or more granular rights, the entity that used one or more granular rights and the revenue data describing how much the owner should be compensated for other's use of the granular right. The ownership resolution module 195 sends the merged report to the payment system 190.

The payment system 190 includes code and routines for sending revenue generated from the usage of a granular right associated with an asset to a real owner. In one embodiment, the payment system 190 receives the merged report from the ownership resolution module 195 and sends a payment to the real owner based on the merged report. For example, the payment system 190 sends an amount of money to the real owner based on a merged report. In one embodiment, the payment system 190 is comprised within the asset hosting site 100. In another embodiment, the payment system 190 is comprised within the server 186. The server 186 is described in more detail below.

The presentation module 110 includes code and routines that, when executed by a processor (not pictured), presents any information intended for a user to a corresponding client device such as the client 120. For example, the presentation module 110 generates a graphic associated with the assets stored in the asset database 116 or the ownership information stored in the ownership database 128 and sends the graphic to a web browser (not pictured) installed in the client 120 via the front end interface 102 and the network 122.

The content provider 118 is any device that provides assets to the asset hosting site 100. For example, the content provider 118 is a computing device that uploads an asset to the asset hosting site 100. The content provider 118 is communicatively coupled to the network 122. In one embodiment, the content provider 118 is also a client 120. In another embodiment, the content provider 118 is an owner A 180 and/or an owner B 184. In yet another embodiment, the content provider 118 is the same entity that operates the asset hosting site 100.

In one embodiment, the content provider 118 is configured to operate a client device to perform various content provider functions. Examples of the content provider functions include, but are not limited to: uploading an asset to the asset hosting site 100; editing an asset stored by the asset hosting site 100; removing an asset from the asset hosting site 100; and editing content provider preferences associated with an asset.

The client 120 is any processor-based computing device. The client 120 executes client software such as a web browser or built-in client application and connects to the asset hosting site 100 via the network 122. In one embodiment, the client 120 includes a variety of different computing devices. Examples of a client device 120 include, but are not limited to: a personal computer; a personal digital assistant; a television set-up box; a tablet computer; a smart phone; and a laptop computer. The client 120 comprises a processor (not pictured), a memory (not pictured) and other components conventional to a computing device. In one embodiment, the client 120 is communicatively coupled to the network 122.

In one embodiment, the client 120 is configured as a content provider 118 to provide assets to the asset hosting site 100. In another embodiment, the client 120 is also configured as an owner A 180 or an owner B 184 to provide information associated with a granular right of an asset to the asset hosting site 100. In yet another embodiment, the client 120 is configured to retrieve assets stored by the asset hosting site 100. For example, the client 120 includes an embedded video player (e.g., the Flash™ player from Adobe System, Inc.) adapted for the video content formats used in the asset hosting site 100 so that a user is able to view a video from the asset hosting site 100 using the embedded video player.

The owners 180, 184 are any device that provides information associated with a granular right of an asset to the asset hosting site 100. For example, the owner A 180 is a computing device that submits an ownership claim for a granular right of an asset and sends the claim to the asset hosting site 100. In one embodiment, the owner A 180 and owner B 184 provide one or more of an ownership claim and an ownership query to the asset hosting site 100. The owner A 180 and owner B 184 are communicatively coupled to the network 122. The owner A 180 and the owner B 184 can be different types of devices. For example, the owner A 180 is one type of computing device (e.g., a hardware server) and the owner B 184 is a different type of computing device (e.g., a personal computer).

In the depicted embodiment, the owner A 180 comprises a feed serving module 182. The feed serving module 182 includes code and routines that generates a feed for automated submissions of ownership claims. For example, the feed serving module 182 processes the ownership information provided by a user of the owner A 180, forms a feed based on the ownership information and transmits the feed to the feed receiving module 124 via the network 122. In one embodiment, the feed includes one or more ownership claims.

The server 186 is any hardware server device. For example, the server 186 is a hardware server operated by Google® of Mountain View, Calif. In one embodiment, the server 186 provides information associated with an asset to a real owner of one or more granular rights of the asset. The server 186 is communicatively coupled to the network 122 via a signal line 111. For example, the server 186 receives a merged report from the ownership resolution module 195 and sends a payment to a real owner via the network 122. In one embodiment, the server 186 comprises a payment system 190.

### Ownership Resolution Module

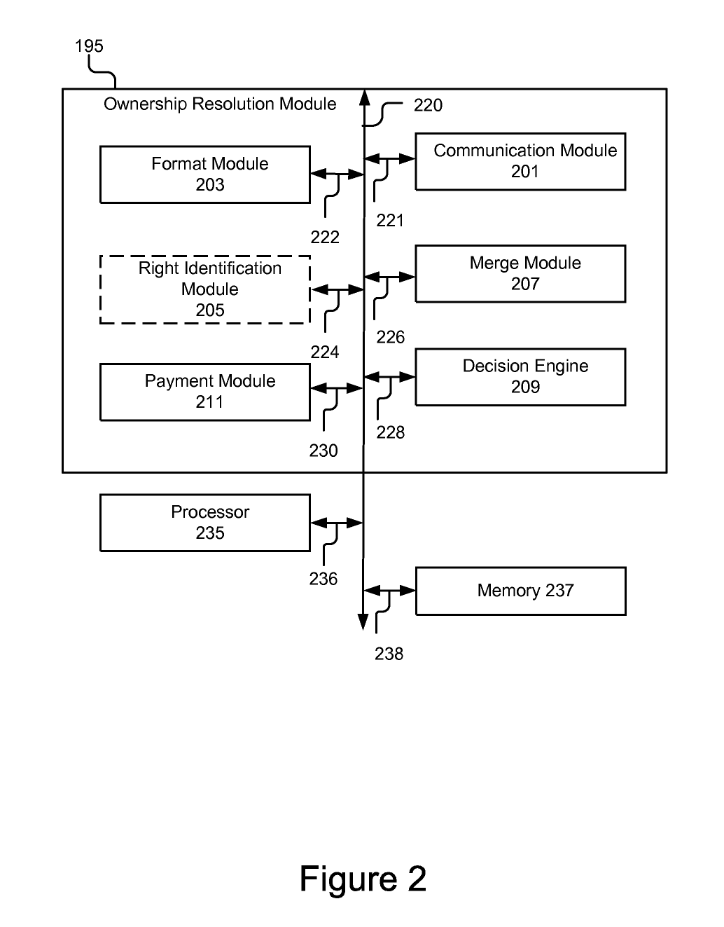

Referring now to FIG. 2, the ownership resolution module 195 is shown in more detail. FIG. 2 is a block diagram illustrating the ownership resolution module 195, a processor 235 and a memory 237 according to one embodiment. The processor 235 comprises an arithmetic logic unit, a microprocessor, a general purpose controller or some other processor array to perform computations, retrieve data stored on the memory 237, etc. The processor 235 is coupled to the bus 220 for communication with the other components. Processor 235 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. The processing capability may be limited to supporting the display of images and the capture and transmission of images. The processing capability might be enough to perform more complex tasks, including various types of feature extraction and sampling. It will be obvious to one skilled in the art that other processors, operating systems, sensors, displays and physical configurations are possible. The processor 235 is communicatively coupled to the bus 220 via a signal line 236.

The memory 237 stores instructions and/or data that are executed by the processor 235. The memory 237 is communicatively coupled by the bus 220 for communication with the other components of ownership resolution module 195. In one embodiment, the instructions and/or data comprises code for performing any and/or all of the techniques described herein. The memory 237 is a dynamic random access memory (DRAM) device, a static random access memory (SRAM) device, flash memory or some other memory device known in the art. In one embodiment, the memory 237 also includes a non-volatile memory or similar permanent storage device and media such as a hard disk drive, a floppy disk drive, a compact disc read only memory (CD-ROM) device, a digital versatile disk read only memory (DVD-ROM) device, a digital versatile disk random access memories (DVD-RAM) device, a digital versatile disk rewritable (DVD-RW) device, a flash memory device, or some other non-volatile storage device known in the art. The memory 237 is communicatively coupled to the bus 220 via a signal line 238.

The ownership resolution module 195 comprises a communication module 201, a format module 203, a merge module 207, a decision engine 209 and a payment module 211. The ownership resolution module 195 communicates with other components of the asset hosting site 100 via the communication module 201. For example, the ownership resolution module 195 sends data to and/or receives data from the usage and revenue database 192 via the communication module 201. In one embodiment, the ownership resolution module 195 optionally includes a right identification module 205. The right identification module 205 is depicted in FIG. 2 using a dashed line to indicate that it is an optional feature of the ownership resolution module 195.

The communication module 201 is an interface that handles communication between components of the ownership resolution module 195 and other components of the asset hosting site 100. The communication module 201 also handles communication between the format module 203, the right identification module 205, the merge module 207, the decision engine 209 and the payment module 211. In the depicted embodiment, the communication module 201 is communicatively coupled to the bus 220 via a signal line 221. In one embodiment, the communication module 201 retrieves ownership information from the ownership database 128 and sends the ownership information to the format module 203 via the bus 220.

The format module 203 includes code and routines for standardizing the format of ownership information pieces and generating a unified table based at least in part on the ownership information (e.g., Table 1 depicted above and described with reference to FIG. 1). In one embodiment, the format module 203 comprises a parser for parsing ownership information pieces from the ownership information received from the communication module 201. The format module 203 converts the ownership information pieces to a standard format (e.g., SQL). For example, the format module 203 comprises a SQL compiler that compiles the ownership information pieces in a SQL data structure (i.e., the unified table). Persons having ordinary skill in the art will recognize that the format module 203 may implement different techniques to convert the ownership information pieces into a standard format. The format module 203 organizes the standardized ownership information pieces to form the unified table.

In one embodiment, the format module 203 generates the unified table based at least in part on the ownership information. For example, the format module 203 generates the unified table based at least in part on the source of the ownership information (e.g., whether the ownership claim is received via a manual source or an automated source). The source of the ownership information includes one or more of a feed, a letter, an email and an online form. For example, Table 1 described below with reference to FIG. 3 is generated based on the source of the ownership information because it includes a column depicting the source of the ownership claim (e.g., the column titled “Asserting Entity and Claim Source”). In another embodiment, the format module 203 generates a unified table based at least in part on the source of the ownership information in which the ownership claims from automated sources are placed in one column and the ownership claims for manual sources are placed in a second column.

The format module 203 is communicatively coupled to the bus 220 via a signal line 222. In one embodiment, the format module 203 retrieves the ownership information of an asset from the communication module 201 and provides the unified table to the merge module 207 via the bus 220.

The right identification module 205 includes code and routines for determining one or more granular rights of an asset. For example, assuming an asset is a book, the right identification module 205 determines that the granular rights of the book include one or more of a distribution right, a publishing right and a right to make a derivative work, etc. However, if the asset is a song, the right identification module 205 determines that the granular rights related to the song include one or more of a distribution right, a public performance right, a reproduction right, a sync right and a right to make a derivative work, etc.

In one embodiment, the right identification module 205 is communicatively coupled to the bus 220 via a signal line 224. In one embodiment, the right identification module 205 retrieves ownership information of an asset from the ownership database 128, analyzes the ownership information to identify one or more granular rights of the asset and provides the identified granular rights to the merge module 207.

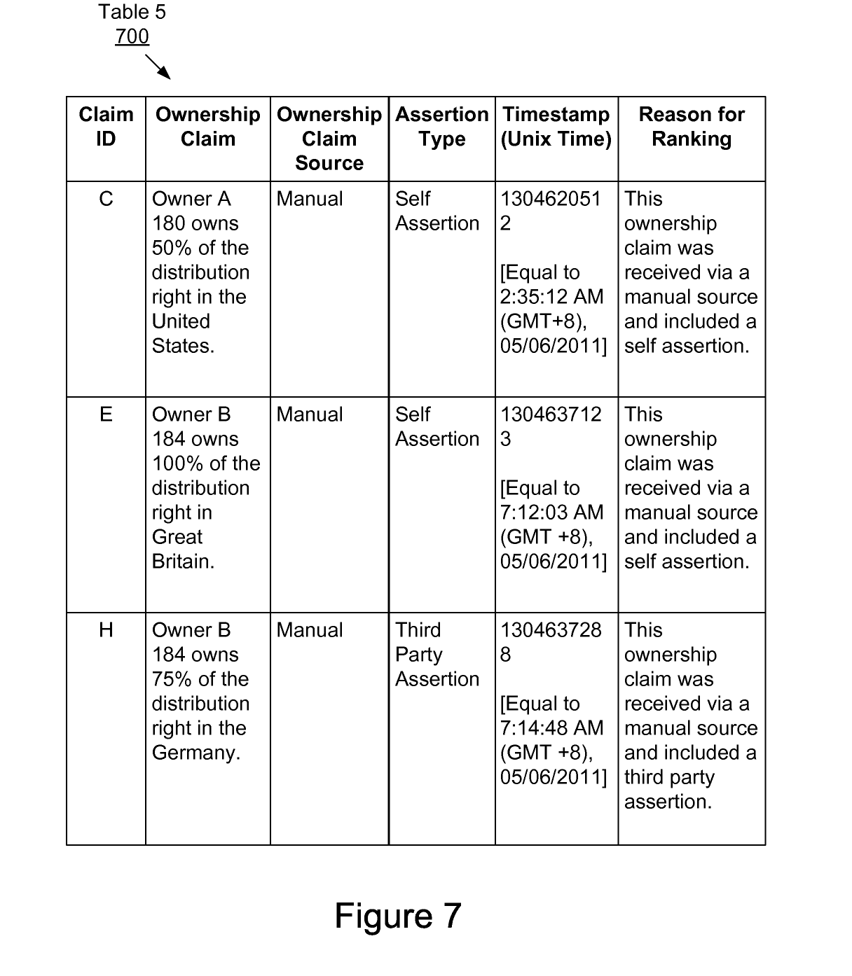

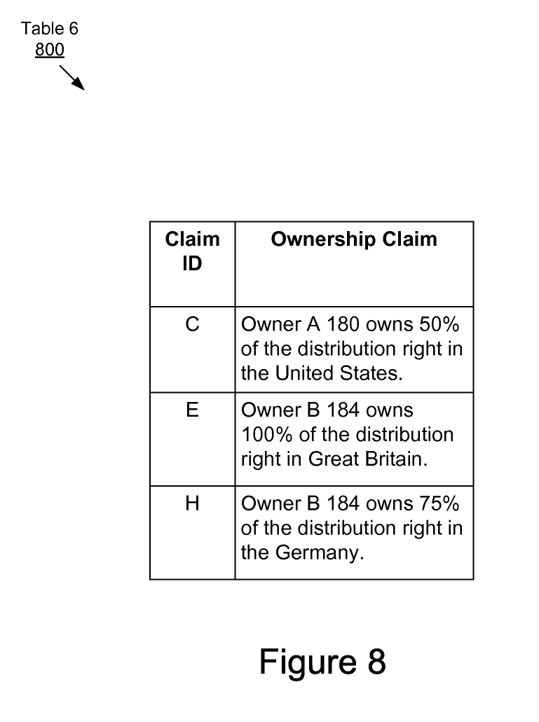

The merge module 207 includes code and routines for merging the ownership information associated with one or more granular rights identified by the right identification module 205 based at least in part on the merging rules. For example, the merge module 207 receives the unified table from the format module 203 and one or more granular rights from the right identification module 205, extracts ownership information pieces from the table associated with the one or more granular rights, merges the ownership information pieces extracted from the table, generates a preliminary merge result and prioritizes the preliminary merge result to generate the final merge result. The merging process is described in more detail with reference to FIGS. 3-8. For example, FIG. 7 depicts an example of a preliminary merge result and FIG. 8 depicts an example of a final merge result. The final merge result is generated by the merge module 207 based at least in part on the merging rules described above for FIG. 1. The merge module 207 is communicatively coupled to the bus 220 via a signal line 226. In one embodiment, the merge module 207 receives a unified table from the format module 203 via the bus 220 and provides the final merge result to the decision engine 209 via the bus 220.

The decision engine 209 includes code and routines for determining a real owner for one or more granular rights of an asset. For example, the decision engine 209 determines a real owner of a granular right for an asset based at least in part on the final merge result. An example of this is described below with reference to FIG. 8. The decision engine 209 generates a report and/or a table describing the real owner of the one or more granular rights for the asset. If an ownership conflict exists, the decision engine 209 determines whether the ownership conflict is resolvable. An ownership conflict is an inconsistency that occurs when a total percentage of ownership claimed for a granular right in a jurisdiction exceeds 100%. For example, an ownership conflict occurs when an owner A 180 claims 50% of distribution right of an asset in Germany while an owner B 184 claims 60% of distribution right of the same asset in Germany (the total percentage of distribution right of the asset claimed in Germany exceeds 100% because the sum of 50% and 60% is 110%). The decision engine 209 is communicatively coupled to the bus 220 via a signal line 228. In one embodiment, the decision engine 209 receives a merge result from the merge module 207, generates a report (and/or table) describing the real owner for one or more granular rights and provides the report (and/or a table) to the payment module 211 via the bus 220. In one embodiment, the report (and/or the table) includes ownership data such as the name of the real owner, the rights owned by that owner, the percentage owned and administrative data such as a name of an administrator and a policy to be applied.

The payment module 211 includes code and routines for generating a merged report. The payment module 211 is communicatively coupled to the bus 220 via a signal line 230. In one embodiment, the payment module 211: (1) receives a report (and/or a table) from the decision engine 209 via the bus 220; (2) retrieves usage data and revenue data from the usage and revenue database 192 via the communication module 201; (3) generates a merged report as described above for FIG. 1; and (4) provides the merged report to the payment system 190 via the communication module 201.

In one embodiment, the payment module 211 calculates new data for inclusion in the merged report. For example, the payment module 211 calculates a total amount of payment owed to the owner based at least in part on the usage data and the revenue data and includes this data in the merged report sent to the payment system 190.

### Tables

Tables 1-6 (elements 300-800, respectively) are depicted in FIGS. 3-8, respectively. Taken together, Tables 1-6 are an example of merging ownership information according to one embodiment. Tables 1-6 assume that different entities are asserting ownership for the distribution right for a particular asset in different jurisdictions. For example, three different distribution companies are asserting ownership of the distribution right to a song in different jurisdictions.

FIG. 3 depicts Table 1 300. Table 1 300 is a unified table that includes organized ownership information pieces that have been standardized so that they are in a standard format. The ownership resolution module 195 retrieves ownership information from the ownership database 128. Pieces of the ownership information are extracted from the ownership information retrieved from the ownership database 128. Ownership information pieces are all or a subset of the ownership information used to make a determination about which entity is the real owner of a granular right. For example, the ownership resolution module 195 comprises a parser that parses the ownership information retrieved from the ownership database 128 to identify the ownership pieces. The ownership resolution module 195 standardizes the ownership information pieces into a standard format. In one embodiment, the ownership resolution module 195 comprises a compiler that compiles the ownership information pieces into a standardized data structure. For example, the ownership resolution module 195 comprises a Structured Query Language (“SQL”) compiler that compiles the ownership information pieces to form a unified table that is a SQL data structure.

An entity can claim that a purported owner owns a granular right in more than one jurisdiction. For example, in claim E owner B 184 is alleged to own a portion of the distribution right for an asset in Great Britain, and in claim H owner B 184 is alleged to own a portion of the distribution right for the asset in Germany. Table 1 300 is organized based on the source of the ownership information. Specifically, Table 1 300 is organized based on the asserting entity and the source of the ownership claim (i.e., whether the ownership claim was received via a manual source or an automated source). In one embodiment, the ownership resolution module 195 stores Table 1 300 in the ownership database 128. In another embodiment, the ownership resolution module 195 stores one or more of Tables 1-6 in the ownership database 128 (Tables 2-6 are described below). In one embodiment the data depicted for Table 1 300 is stored in a matrix and the matrix is stored in the ownership database 128.

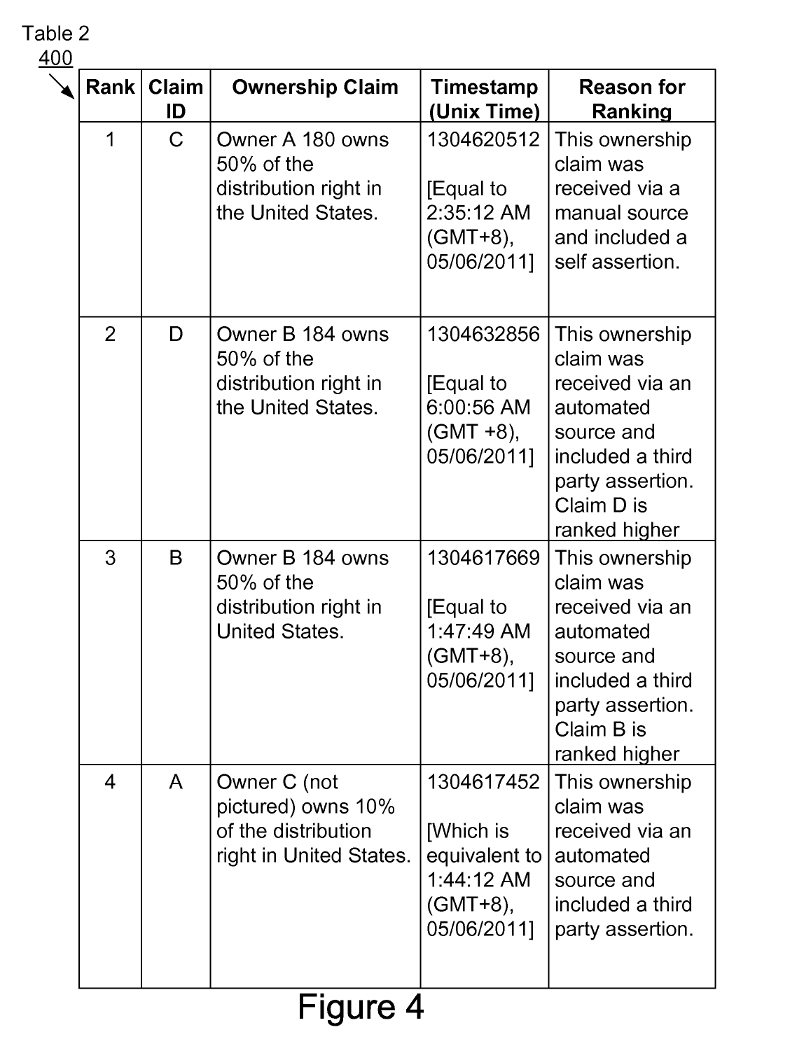

FIG. 4 depicts Table 2 400. Table 2 400 is a subset of Table 1 300 in that Table 2 400 depicts a ranking for the ownership claims submitted by owner A 180 in Table 1. In Table 2 400 the ownership rights are ranked for each of the asserting entities based on the merging rules described above so that preference is given to ownership claims received from manual sources, ownership claims that include self assertions and the most recent ownership claim. In one embodiment, the unified table of Table 1 300 does not include timestamps for each ownership claim and the ranking of the ownership claims is not based the time rule described above in which preference is given to ownership claims that are received later in time. For example, claims are ranked based on the source rule and the assert type rule so that preference is given to ownership claims received from manual sources and ownership claims that include self assertions.

Claim C was received from a manual source but included a self assertion. Claim A, claim B and claim D are all received via an automated source and include third party assertions. However, claim D is ranked higher than claims A or B since it was received latest in time. Similarly, claim B is ranked higher than claim A since claim B was received later in time.

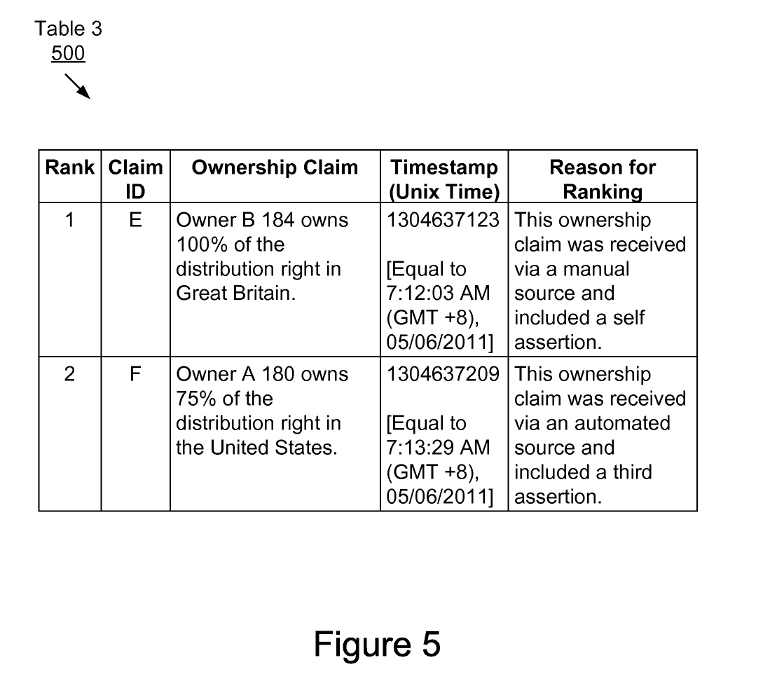

FIG. 5 depicts Table 3 500. Table 3 500 is a subset of Table 1 300 in that Table 3 500 depicts a ranking for the ownership claims submitted by owner B 184 in Table 1. Like Table 2 400 described above, in Table 3 500 the ownership rights are ranked so that preference is given to ownership claims received from manual sources, ownership claims that include self assertions and the most recent ownership claim. In Table 3 500, claim E is ranked higher than claim F since claim E was received via manual submission and included a self assertion.

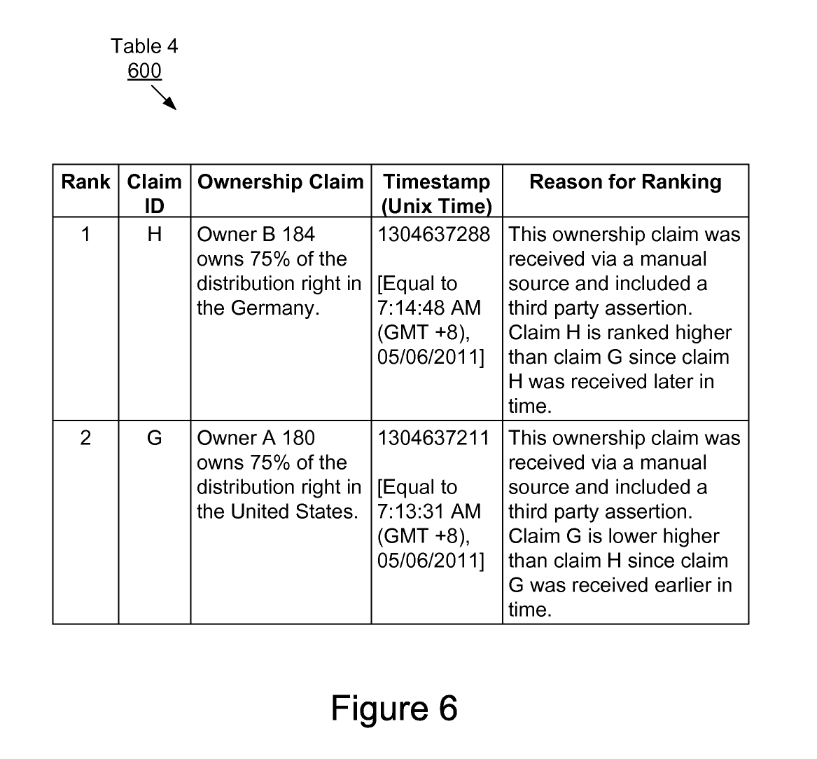

FIG. 6 depicts Table 4 600. Table 4 600 is a subset of Table 1 300 in that Table 4 600 depicts a ranking for the ownership claims submitted by owner B 184 in Table 1. In Table 4 600, the ownership rights are ranked so that preference is given to ownership claims received from manual sources, ownership claims that include self assertions and the most recent ownership claim. Claim G and claim H are both received from a manual source and include a third party assertion. However, claim H was received later in time. As a result, claim H is ranked higher than claim G in Table 4 600.

FIG. 7 depicts Table 5 700. Table 5 700 is an example of a merge result. The ownership information in Tables 2, 3 and 4 (elements 400, 500 and 600, respectively) are filtered to form a preliminary merge result. The preliminary merge result includes the highest ranked information submitted by each entity. Since claims C, E and H were the highest ranked claims from Table 2 400, Table 3 500 and Table 4 600, respectively, these claims are included in Table 5 700 and form the preliminary merge result for this example. In one embodiment, the preliminary merge result includes ownership information pieces. An ownership piece is data describing a portion of an ownership claim. For example, for Table 5 700, the data included in the column labeled “Ownership Claim,” “Ownership Claim Source,” “Assertion Type” and “Timestamp (UTC)” are ownership information pieces.

The next step is to prioritize the ownership information included in the preliminary merge result by (1) comparing the ownership information for each purported owner to determine if there is a disagreement and (2) for each identified disagreement, deleting the ownership information that is from the less reliable source based on the merging rules. This process forms the final merged result. In Table 5 700, the ownership claims are not in disagreement. However, assume that for Table 4 600, claim G had been the highest ranked claim. In this scenario ownership claims C and G are in disagreement because ownership claim C states that owner A 180 owns 50% of the distribution right in the United States whereas ownership claim G states that owner A 180 owns 75% of the distribution right in the United States. Since ownership claim C was a self assertion and ownership claim G was a third party assertion, the ownership resolution module 195 determines ownership claim C to be more reliable and ownership claim G is deleted.

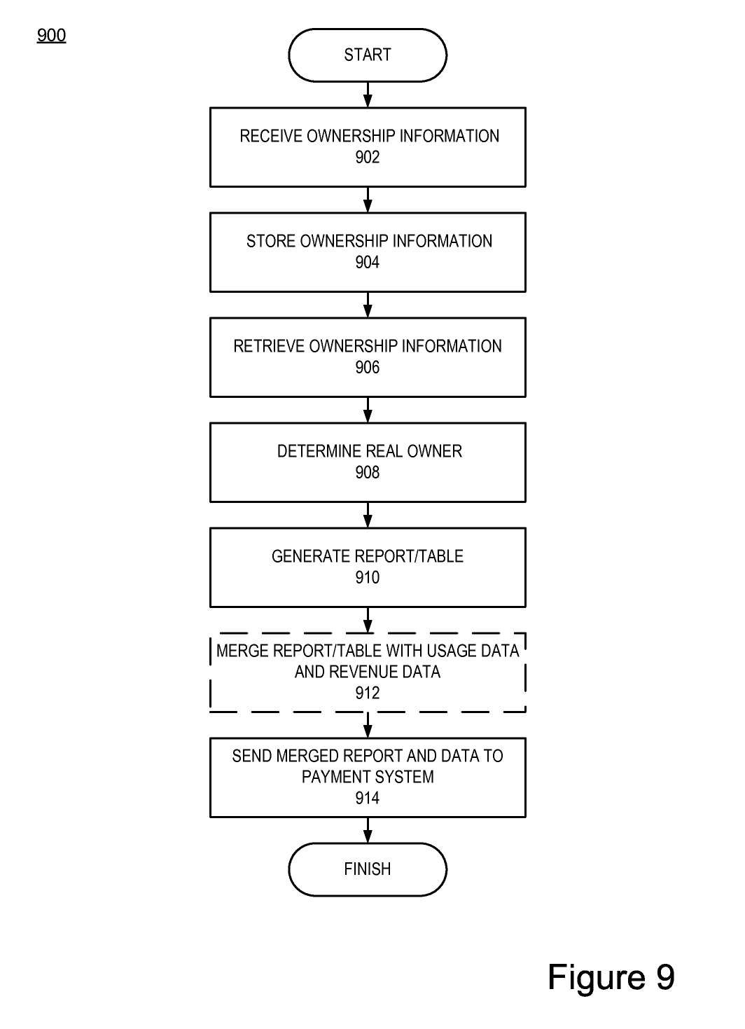

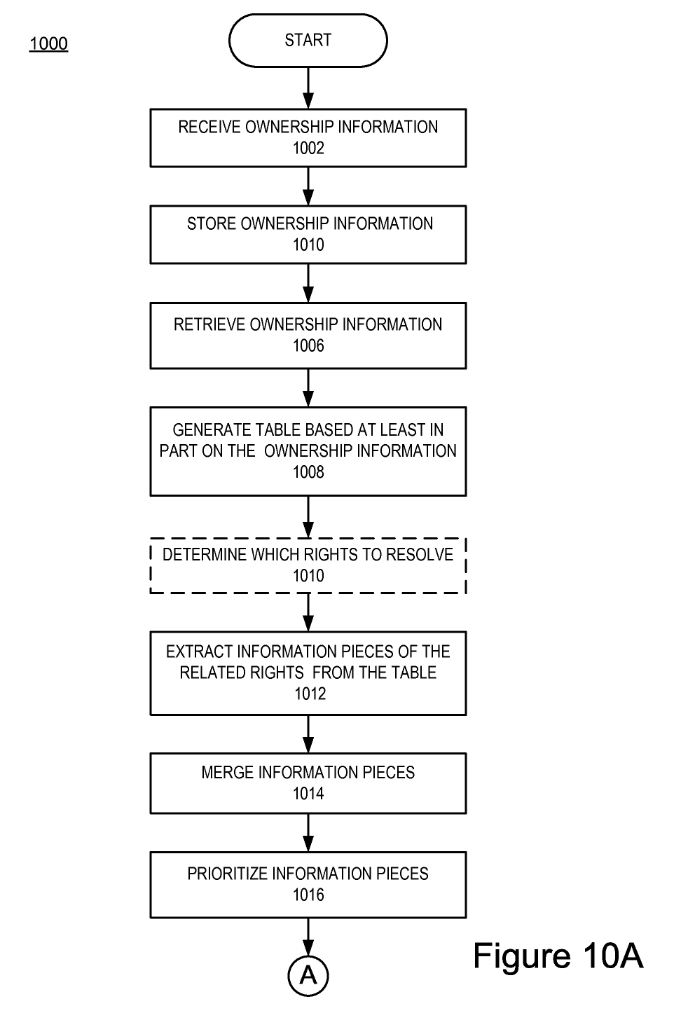

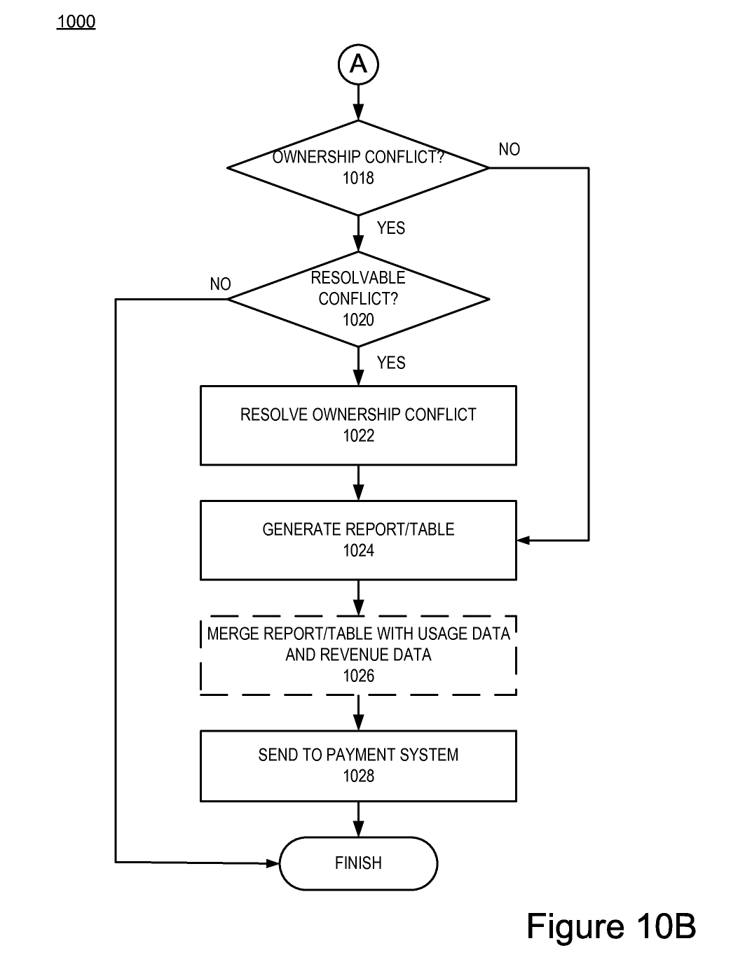

FIG. 8 depicts Table 6 800. Table 6 800 is the final merge result for the example described above for FIGS. 3-7. The ownership resolution module 195 analyzes the final merge result to determine that Owner A 180 owns 50% of the distribution right in the United States and Owner B 184 owns 100% of the distribution right in Great Britain and 75% of the distribution right in Germany. The methods implemented by the ownership resolution module 195 are described in more detail with reference to FIGS. 9, 10A and 10B.

In one embodiment, one or more of Tables 1-6 (elements 300-800, respectively) are SQL data structures generated by a SQL compiler. For example, a SQL compiler compiles the ownership information to form Table 1 300 and Table 1 300 is a SQL data structure. In another embodiment, the data depicted for Tables 1-6 are stored in one or more matrices.

### Methods

Referring now to FIG. 9 and FIGS. 10A and 10B, various embodiments of the method of the specification will be described. FIG. 9 is a flow diagram 900 of a method for ownership resolution according to one embodiment. The front end interface 102 receives 902 the ownership information associated with assets from one or more of a content provider 118, a client 120, an owner A 180 and an owner B 184. The ownership information is received via one or more of a feed, an email, inputs entered into a GUI (e.g., an online claim) and an administrator of the asset hosting site 100 manually entering ownership information received via a manual source such as a letter. The front end interface 102 stores 904 the ownership information in the ownership information database 128. The ownership resolution module 195 retrieves 906 the ownership information from the ownership information database 128. The ownership resolution module 195 determines 908 a real owner for the one or more granular rights. The ownership resolution module 195 generates 910 a report (and/or a table) describing the real owner of the one or more granular rights. In one embodiment, the ownership resolution module 195 merges 912 the report and/or the table with the usage data and the revenue data to generate a merged report. The ownership resolution module 195 sends 914 the merged report and other data associated with the merged report to the payment system 190.

FIGS. 10A and 10B are flow diagrams of a method for ownership resolution according to another embodiment. Referring to FIG. 10A, the front end interface 102 receives 1002 ownership information associated with one or more assets from one or more of a content provider 118, a client 120, an owner A 180 and an owner B 184. The ownership information is received via one or more of a feed, an email, inputs entered into a GUI (e.g., an online claim) and an administrator of the asset hosting site 100 manually entering ownership information received via a manual source such as a letter. At step 1004, the front end interface 102 stores 1004 the ownership information associated with assets in the ownership database 128.

The communication module 201 retrieves 1006 the ownership information of the asset from the ownership database 128 and sends the ownership information to the format module 203. At step 1008, the format module 203 generates 1008 a unified table based at least in part on the ownership information. In one embodiment, the right identification module 205 receives the ownership information from the communication module 201 and determines 1010 one or more granular rights related to the asset. The merge module 207 receives the unified table including the ownership information from the format module 203. At step 1012, the merge module 207 extracts 1012 ownership information pieces of the related rights from the unified table. For example, the merge module 207 extracts 1012 ownership information pieces from the table. At step 1014, the merge module 207 merges 1014 the ownership information pieces extracted from the table based at least in part on one or more of the merging rules. In one embodiment, the merge module 207 ranks and prioritizes 1016 the ownership information pieces based at least in part on one or more of the merging rules to form a final merge result. For example, the merge module 207 ranks the ownership information pieces from most reliable to least reliable based on the merging rules and filters out the most reliable ownership information to form a final merge result.

Now referring to FIG. 10B, the decision engine 209 receives the final merge result from the merge module 207 and determines 1018 whether an ownership conflict occurs in the final merge result. If the total percentage of ownership for a related granular right of an asset in a jurisdiction region exceeds 100%, the decision engine 209 determines an ownership conflict occurs and the method 1000 moves to step 1020. If an ownership conflict does not occur, the method moves to step 1024.

At step 1020, the decision engine 209 determines 1020 whether the ownership conflict is resolvable based at least in part on the merging rules. If the decision engine 209 determines that the ownership conflict is resolvable, the method 1000 moves to step 1022. If the conflict is not resolvable, the method 1000 ends. At step 1022, the decision engine 209 resolves 1022 the ownership conflict and determines the real owner for the related right of the asset. At step 1024, the decision engine 209 generates 1024 a report and/or a table describing the real owner. For example, the report and/or the table include ownership data such as the name of the real owner, the jurisdiction in which the ownership applies and the percentage of the granular right that the owner owns.

The payment module 211 receives the report (and/or the table) from the decision engine 209 and retrieves the usage data and revenue data from the usage and revenue database 192. At step 1026, the payment module 211 merges 1026 the report and/or the table of the real owner with the usage data and revenue data and generates a merged report. In one embodiment, the payment module 211 also includes other data in the merged report. For example, the payment module 211 calculates the total amount of payment to an owner based on the report and/or the table of the real owner, usage data and revenue data and generates a merged report including the total amount of payment. At step 1028, the payment module 211 sends 1028 the merged report to the payment system 190.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to implementation in any specific programming language, or for any specific operating system or environment. Accordingly, the disclosure is intended to be illustrative, but not limiting, of the scope of the specification, which is set forth in the following claims.

What is claimed is:

1. A method for ownership resolution, the method comprising:
merging ownership information associated with an intellectual property asset to form a final merge result based at least in part on one or more merging rules;
determining a real owner of a granular right based at least in part on the final merge result; and
generating a first report describing the real owner of the granular right.

2. The method of claim 1, wherein the granular right comprises one or more of a public performance right, a reproduction right, a distribution right, a sync right and a right to make a derivative work.

3. The method of claim 1, wherein the merging rule comprises one or more of a source rule, an assert type rule and a time rule.

4. The method of claim 1, wherein the ownership information is submitted by one or more asserting entities and merging the ownership information comprises:
ranking, for the one or more asserting entities, the ownership information from most reliable to least reliable based on the merging rules; and
filtering the most reliable ownership information for the one or more asserting entities so that the determining of the real owner is based on the most reliable ownership information.

5. The method of claim 1, further comprising merging the first report with usage and revenue data to form a second report that includes a description of the real owner and revenue owed to the real owner.

6. The method of claim 5, further comprising submitting the second report to a payment system.

7. A computer program product comprising a non-transitory computer readable medium encoding instructions that, in response to execution by a computing device, cause the computing device to perform operations comprising:
merging ownership information associated with one or more intellectual property assets to form a final merge result based at least in part on one or more merging rules;
determining a real owner of a granular right based at least in part on the merged ownership information; and
generating a first report describing the real owner of the granular right.

8. The computer program product of claim 7, wherein the granular right comprises one or more of a public performance right, a reproduction right, a distribution right, a sync right and a right to make a derivative work.

9. The computer program product of claim 7, wherein the merging rule comprises one or more of a source rule, an assert type rule and a time rule.

10. The computer program product of claim 7, wherein the ownership information is submitted by one or more asserting entities and merging the ownership information comprises:
ranking, for the one or more asserting entities, the ownership information from most reliable to least reliable based on the merging rules; and
filtering out the most reliable ownership information for the one or more asserting entities so that the determining of the real owner is based on the most reliable ownership information.

11. The computer program product of claim 7, wherein the computer readable program further comprises instructions for causing the computer to perform the step of merging the first report with usage and revenue data to form a second report that includes a description of the real owner and revenue owed to the real owner.

12. A system for ownership resolution, the system comprising:
a merge module communicatively coupled to an ownership database to retrieve a unified table including ownership information associated with one or more intellectual property assets that is converted to a standard format, the merge module configured to merge the ownership information to form a final merge result based at least in part on one or more merging rules; and
a decision engine communicatively coupled to the merge module to receive the final merge result from the merge module, the decision engine configured to determine a real owner of a granular right based at least in part on the merged ownership information and generate a first report describing the real owner of the granular right.

13. The system of claim 12, wherein the granular right comprises one or more of a public performance right, a reproduction right, a distribution right, a sync right and a right to make a derivative work.

14. The system of claim 12, wherein the merging rule comprises one or more of a source rule, an assert type rule and a time rule.

15. The system of claim 12, wherein the ownership information is submitted by one or more asserting entities and the merge module is further configured to rank, for the one or more asserting entities, the ownership information from most reliable to least reliable based on the merging rules and filter out the most reliable ownership information for the one or more asserting entities so that the determining of the real owner is based on the most reliable ownership information.

16. The system of claim 12 further comprising a payment module and a payment system, and wherein:
the payment module is communicatively coupled to receive the first report from the determination engine and merge the first report with usage and revenue data to form a second report that includes a description of the real owner and revenue owed to the real owner.
the payment system is communicatively coupled to receive the second report from the payment module and pay the real owner revenue based at least in part on the second report.

17. The system of claim 16, wherein the payment system is communicatively coupled to receive the second report from the payment module and pay the real owner revenue based at least in part on the second report.
